(19) United States
(12) Patent Application Publication
(10) Pub. No.: US 2011/0010946 A1
(43) Pub. Date: Jan. 20, 2011

(54) PIPE CUTTING AND CHAMFERING TOOL

(76) Inventor: Mervyn Wilson, Norfolk (GB)

Correspondence Address: DEFILLO & ASSOCIATES, INC., P.O. Box 14104, Clearwater, FL, 33766, US

(21) Appl. No.: 12/933,099

(22) PCT Filed: Mar. 19, 2008
(86) PCT No.: PCT/GB08/01010

§ 371 Date: Sep. 17, 2010

(51) Int. Cl. B23D 21/00

(52) U.S. Cl. 30/95

(57) ABSTRACT

A pipe cutting and chamfering tool comprises one or more cutting portions for severing the pipe into two portions; one or more chamfering portions for chamfering the edges of said pipe portions; wherein the cutting and chamfering portions is or are configured to be driven.

### CROSS REFERENCE TO RELATED APPLICATION

This application is a national stage entry of PCT/GB2008/001010 filed Mar. 19, 2008, under the International Convention.

### FIELD OF THE INVENTION

The invention relates to pipe cutting and chamfering tools.

### BACKGROUND TO THE INVENTION

Waste pipes for example the well known brown pipes made of plastics material are conventionally first severed in two portions using a hand saw and then once the respective ends of the portions are exposed, they are sequentially chamfered. The usual method employed is a hand file although automatic chamfering tools exist which are placed on an individual pipe portion end and then rotated until a chamfer is achieved around the circumference of the pipe on a single end portion.

Chamfering tools require the pipes to be accessed in their longitudinal direction. Thus, chamfering in confined spaces, for example when fitting a junction to a buried pipe, would normally require dismantling and/or displacement of the buried pipe, which are both difficult and time wasting.

One of the problems the invention addresses is how to cut and chamfer pipes even when these are difficult to access. Another object of the invention is to reduce the number of actions required to cut and chamfer a pipe.

The following prior art documents are acknowledged: DE 2305633; U.S. Pat. No. 6,129,488; and U.S. 4,084,463. DE 2305633 fails to show a tool which would be portable since it is destined to be mounted on a workbench. It also requires the insertion of the pipe through the open ends of a ring. The prior art tool would therefore not be suitable for operation in spaces which would be difficult to access or off-site.

### SUMMARY OF THE INVENTION

In a first broad independent aspect, the invention provides a pipe cutting and chamfering tool comprising one or more cutting portions for severing the pipe into two portions; one or more chamfering portions for chamfering the edges of said pipe portions; wherein the cutting and chamfering portions is or are configured to be driven; characterised in that said tool incorporates a jaw for securing the tool onto a pipe from its side and for guiding the relative displacement of said pipe and said cutting and chamfering portions.

In a subsidiary aspect, the pipe is displaced by the operator whilst the cutting and chamfering portions remain in their position. Alternatively, the cutting and chamfering portions are displaced whilst the pipe is held in its position.

In a subsidiary aspect, said means for securing the tool onto a pipe incorporates a jaw. This is particularly advantageous because it allows the tool to be fitted onto a pipe from its side. It also improves the security of attachment of the tool to the pipe.

In a further subsidiary aspect, said jaw incorporates a number of rollers which engage the pipe when said jaw is secured onto said pipe and which act as said guiding means. This configuration is particularly advantageous because it allows the operation to be carried out with greater accuracy than would otherwise be achieved.

In a second broad independent aspect, the invention provides a pipe cutting and chamfering tool which is shaped and configured to be held and carried by hand comprising one or more cutting portions for severing the pipe into two portions; one or more chamfering portions for chamfering the edges of said pipe portions; wherein the cutting and chamfering portions is or are configured to be driven; and the tool incorporates a handle for carrying the tool whilst using the tool.

This configuration is particularly advantageous because it allows pipes to be cut and chamfered in one operation and outside of a workshop or without requiring a work bench. It also allows cutting and chamfering to take place in confined spaces without requiring dismantling or any displacement of the soil pipe. It also minimises the time required for installing a waste pipe system. In addition, it allows the chamfering to be carried out with greater accuracy than any manual system.

In a subsidiary aspect, the tool comprises a clamp for securing the tool onto the pipe and one or more cutting and chamfering portions is or are driven to displace about the circumference of the pipe. This configuration allows the cutting and chamfering operations to be of greater accuracy than would otherwise be the case.

In a further subsidiary aspect, the tool comprises a clamp for securing the tool onto the pipe which incorporates a guide for locating the one or more cutting and chamfering portion relative to the pipe as it is or they are manually displaced about the circumference of the pipe whilst being driven for cutting and chamfering. This configuration is particularly advantageous because it allows the operation to be partly manually operated whilst preserving the velocity of the cutting and chamfering operations.

In a further subsidiary aspect, one or more cutting portions is or are integrally formed with one or more chamfering portions. This configuration is particularly advantageous because it allows the blades to cut the pipe and to chamfer the pipe by using a shaving operation. It also may allow the blades to be replaceable blades.

In a further subsidiary aspect, the cutting and chamfering portions are incorporated into one or more drive trains which is or are driven about the circumference of said pipe. This allows advantageous accuracy to be achieved as well as flexibility to fit around the circumference of the pipe.

In a further subsidiary aspect, the drive train is circular and incorporates a releasable closure means which when opened allows the tool to be removed from the pipe and when closed allows the drive train to rotate about the circumference of the pipe. This allows the tool be fitted onto the pipe from a lateral direction which is particularly advantageous when the pipe is located in a confined space.

In a further subsidiary aspect, the drive train is a chain, which incorporates the cutting and chamfering portions. This allows the drive train to be particularly flexible in order to open and close from a lateral direction onto the pipe.

In a further subsidiary aspect, the tool further comprises a mechanism for automatically switching the displacement of one or more of the cutting and chamfering portions from clockwise to anticlockwise. This configuration is particularly advantageous because it allows a reduced number of cutting and chamfering portions and reduces the amount of displacement required for each individual cutting and chamfering portion.

In a further subsidiary aspect, the tool further comprises a spigot protruding from the tool for engagement with a rotary power tool. This configuration allows the tool to be driven by a rotary power tool without necessarily incorporating the power driving components within the tool.

In a further subsidiary aspect, the one or more cutting and chamfering portions interacts or interact with one or more springs, which, in use, urges or urge the portions towards the pipe. This allows the system to accommodate variations in the diameter of a given soil pipe whilst still maintaining the necessary accuracy for the cutting and chamfering operations.

In a third broad independent aspect, the invention provides a jaw for use with a pipe cutting and chamfering tool according to the first aspect, incorporating means for receiving and securing a power tool; wherein said jaw is sized and shaped to be secured about a pipe.

In a subsidiary aspect, said jaw incorporates a number of rollers which engage the pipe when said jaw is secured onto said pipe and which act as said guiding means.

### BRIEF DESCRIPTION OF THE FIGURES

FIG. 1 shows a top view of a cutting and chamfering tool in accordance with a first embodiment of the invention.

FIG. 2 shows a perspective view of a second embodiment of the invention.

FIG. 3 shows a perspective view of a third embodiment of the invention.

FIG. 4 shows a perspective view of a fourth embodiment of the invention.

FIG. 5 shows a side view of a fifth embodiment of the invention.

FIG. 6 shows a side view of an interlock.

FIG. 7 shows an inside surface view, of a portion, from an enclosing member of the invention.

FIG. 8 shows a perspective view of a sixth embodiment of the invention.

FIG. 9 shows a perspective view of the drive mechanism required for the sixth embodiment of the invention.

FIG. 10 shows a side view of an interlock and clamp.

FIG. 11 shows a perspective view of the jaw from the side where rollers are visible.

FIG. 12 shows the jaw from the opposite side to that shown in FIG. 11.

FIGS. 13 show side elevations. In particular, FIG. 13A shows a side elevation of the jaw from the roller side in its closed position. FIG. 13B shows a side elevation of the jaw in its open configuration from the roller side.

FIG. 13C shows the jaw in its closed position with the cutting and chamfering tool in place.

FIG. 14 shows a side elevation of a hand held power tool incorporating the jaw of FIGS. 11 to 13.

### DETAILED DESCRIPTION OF THE FIGURES

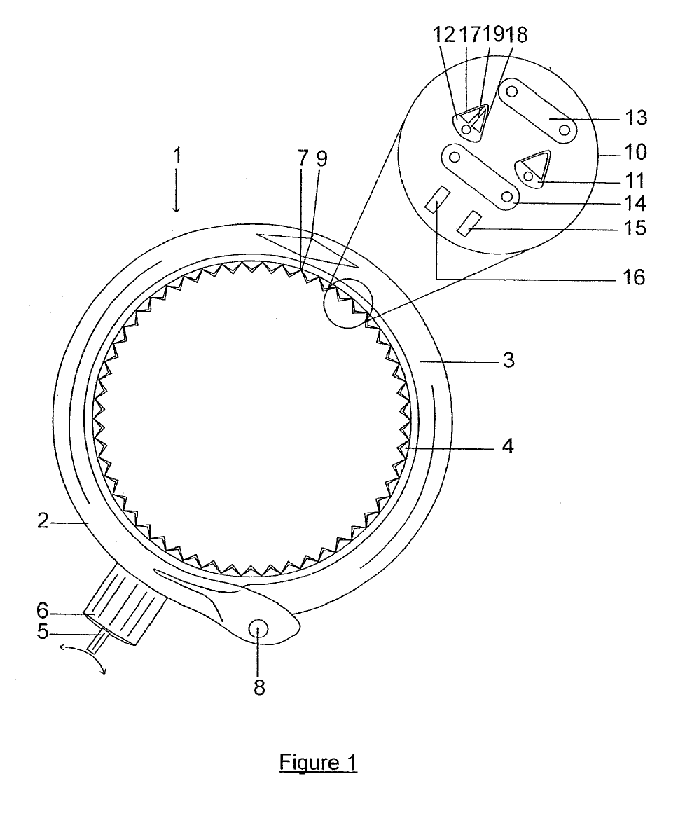

FIG. 1 shows a pipe cutting and chamfering tool generally referenced 1 with a jaw formed of two halves 2 and 3. The jaw may be of rigid material to ensure the accurate positioning of an internal chain 4. A spigot 5, which extends laterally is sized and configured to locate in an appropriate receiving portion (not shown in the figure) of a rotary power tool (not shown in the figure). The rotation may be clockwise or anticlockwise. A gearbox 6 attached to a side of the jaw allows the rotary motion of spigot 5 to cause the inner circumferential rotation of chain 4. The gearbox may be selected optionally as a gearbox, which automatically switches the displacement of the chain from clockwise to anticlockwise.

The chain 4 incorporates a break 7, which allows the jaw to be opened and closed. The chain may incorporate a releasable attachment means such as a latch between the portions on either side of break 7. It is also envisaged that no releasable attachment means between the end portions of the chain may be required. In an embodiment where the chain rotates for example by only a fifth of the circumference in an anticlockwise direction and then back to its starting position in a clockwise direction no releasable attachment means need to be used. Jaw half 2 and jaw half 3 incorporate a hinge 8 and a break 9. On either side of the break 9 there may be releasable attachment means such as a tongue and groove arrangement between the halves to ensure that the jaw remains sufficiently locked during the cutting and chamfering operations.

Chain 4 may incorporate as shown in exploded view 10 a number of wagons, 11 and 12 which are joined together to form a train by a number of linkage members such as members 13 and 14. Wagons 15 and 16 may be driven through appropriately sized apertures in the linkage members and wagons.

Each individual wagon incorporates two cutting edges 17 and 18, which extend in the direction of the circumference. In addition, there is provided on at least one side a chamfering cutting edge 19, which is angled in a range from 5 to 45 degrees dependent upon the chamfering angle required. The chamfering angle is preferred to be 30 degrees from the longitudinal direction of a pipe when fitted inside the jaw. Wagon 11 would incorporate a chamfering edge such as edge 19 in the opposite direction. The wagons may also incorporate both chamfering edges in a first type of wagon and both cutting edges in a second type of wagon. The number of wagons may be varied. In an embodiment where the train is rotated by only a quarter of the circumference a single group of cutting and chamfering wagons may be provided to cover a quarter of the circumference of a pipe. Similarly, only three groups of cutting and chamfering portions may be disposed to cover a third each of an inner circumference of the jaw. In such arrangement, it is particularly advantageous to set the clockwise and anticlockwise rotation to a third of the circumference. It is also envisaged that only one group is provided and then rotated around the entire circumference to realise the cutting and chamfering operation.

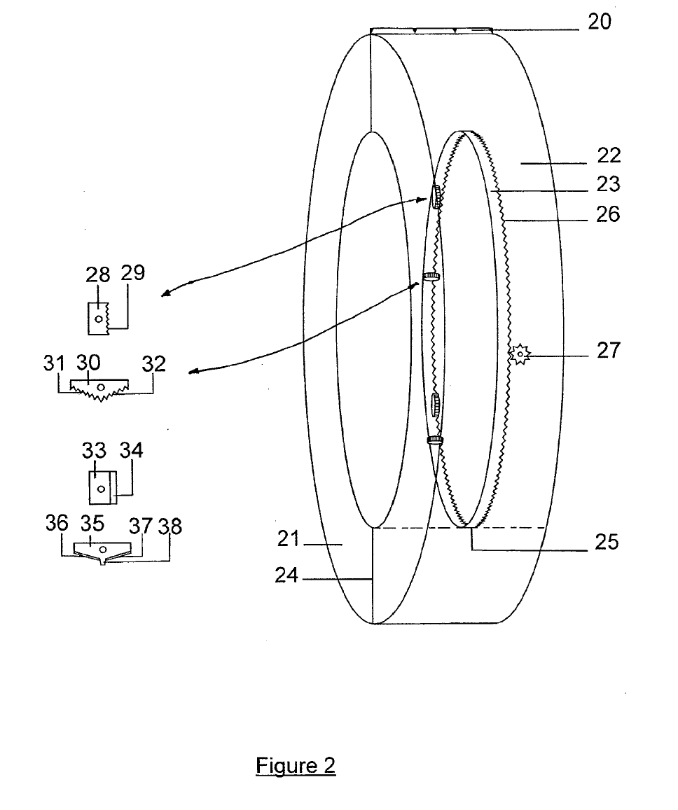

FIG. 2 shows a cutting and chamfering tool with a hinge 20 separating halves 21 and 22. Instead of incorporating a chain, the jaw incorporates a ring 23. Both ring 23 and the jaw incorporates a break respectively referenced 24 and 25 allowing the jaw to be opened and placed from a lateral direction onto a pipe. Ring 23 incorporates a number of gear teeth 26 which match with a gear 27 which may be driven by a drive unit located within the tool. A number of cutting and chamfering portions are disposed on the inside of ring 23. Cutting head 28 incorporates a jagged edge 29 whilst chamfering head 30 incorporates two sloping faces 31 and 32 both of which incorporate a jagged edge.

Cutting head 28 may be replaced by cutting head 33 with a sharp and smooth edge 34.

Chamfering head 30 may be replaced by chamfering head 35 with two sloping edges 36 and 37 which are separated by a projection 38 in order to precisely locate the chamfering head between the severed edges of a pipe. Ring 22 may be biased towards the inside of the jaw and sized and shaped so that when placed about a pipe the cutting and chamfering heads tightly engage the circumference of the pipe.

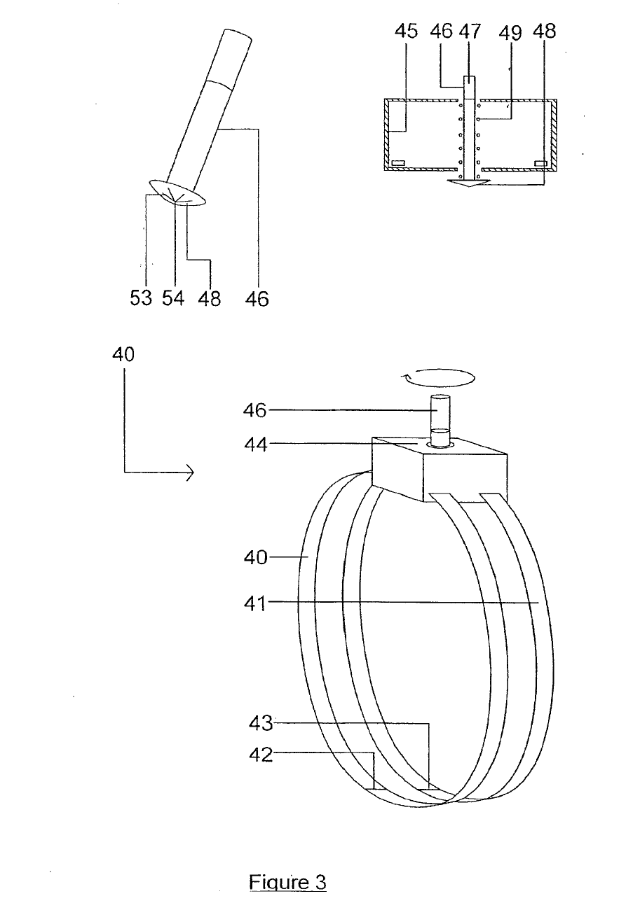

FIG. 3 shows a cutting and chamfering tool generally referenced 39 with two bands 40 and 41, which are sized and shaped to fit tightly onto the circumference of a soil pipe. The tracks incorporate releasable attachment means 42 and 43 allowing the bands to be tightly fitted onto a pipe. The bands act as tracks about which displaceable trolley 44 runs. Trolley 44 incorporates a housing 45 in which a cutting and chamfering member 46 is located with a portion 47 suitable for attachment to a rotary power tool, which protrudes from housing 45 in the radially outwards direction. In the radially inwards direction there is provided a cutting and chamfering head 48. A biasing means such as a spring 49 draws the chamfering and cutting head 48 towards the circumference of the pipe. In this configuration, the rotation of a rotary power tool is directly transmitted to the cutting and chamfering head 48 and it therefore avoids the use of a gearbox as envisaged in FIG. 1.

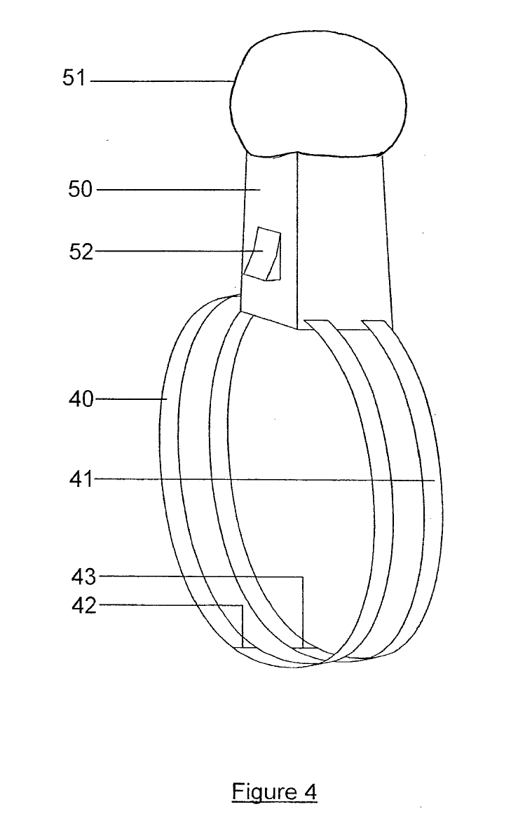

FIG. 4 shows a modification of the embodiment of FIG. 3 where the rotary power tool is integral to the housing of the cutting and chamfering tool. The elements, which are in common with the embodiment of FIG. 3, have retained identical numerical references for clarity. Housing 50 is provided with a handle 51. A rotary motor, a battery and the chamfering and cutting tool are provided in the housing. On the outside of the housing a switch 52 protrudes which allows the tool to be switched on and off.

Cutting and chamfering head 48 is releasable from the housing 45. The cutting and chamfering head incorporates a number of radial cutting lines 53, which slope away from a centre cutting point 54.

FIG. 5 shows an alternative embodiment of the pipe cutting and chamfering tool, which comprises of two semi circular members 55 and 56. Semi circular member 55 retracts into semi circular portion 60 to enable the tool to be placed about a pipe. When the tool is in position about a pipe, semi circular member 55 is extracted from semi circular member 60 to close the tool about the pipe. Semi circular member 55 is then locked into position, by an interlock means within semi circular portion 60.

The interlocking semi circular members 55 and 60 combine to form an annular pipe cutting and chamfering tool about a pipe. The retraction and extraction of semi circular member 55 is show by arrow 57.

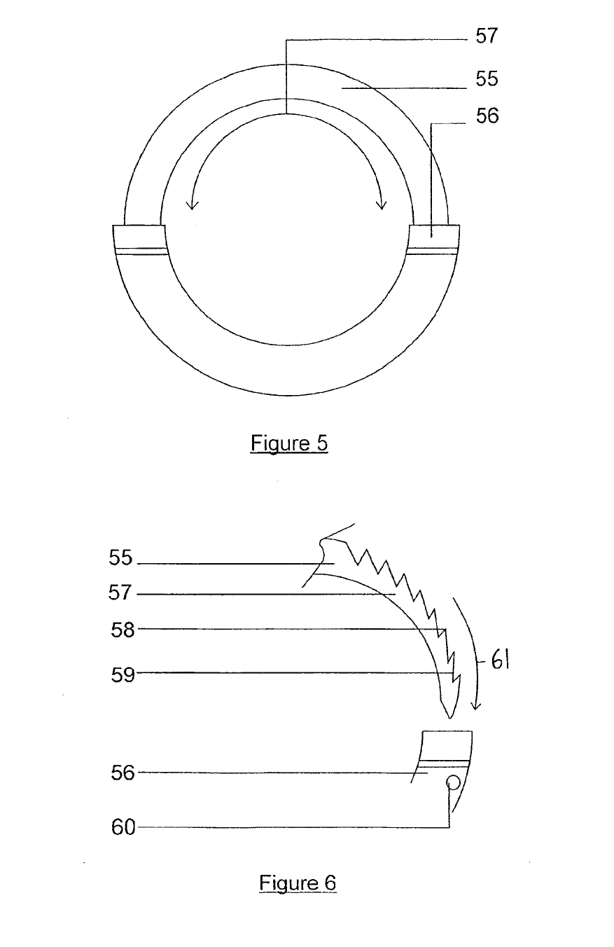

FIG. 6 shows an embodiment of the interlock means for securing the pipe cutting and chamfering tool members 55 and 56 about a pipe. The pipe cutting and chamfering tool member 55 incorporates a rack of teeth 58, which are offset at an angle 59. The rack of teeth 58, are located at an extremity, which is free from member 56.

The pipe cutting and chamfering tool member 56 incorporates a pawl 60. The pipe cutting and chamfering tool member 55 is inserted into member 56. The rack of teeth 58 are passed over the pawl 60, which forms an overall ratchet means that locks member 55 to 56 indicated by arrow 57.

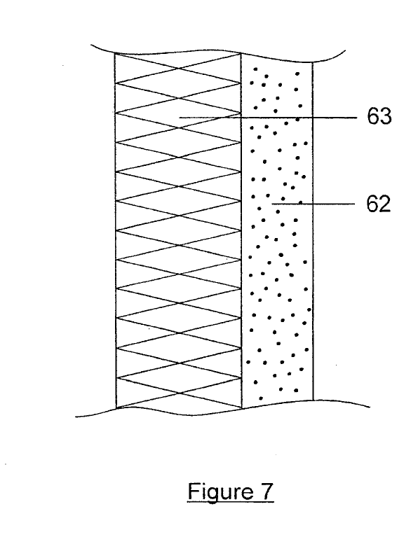

FIG. 7 shows an alternative embodiment of the pipe cutting and chamfering tool, which shows a portion of the inner surface, which is in contact with the pipe's outer surface. The inner surface incorporates a high friction surface 62, which provides extra grip for parking the pipe cutting and chamfering tool onto the pipe's outer surface. The inner surface also incorporates an array of teeth 63, which are vertically arranged in an axial configuration about the pipe. The high friction portion 62 is vertically adjacent to the vertical array of teeth 63, with the high friction portion 62 as the right most portion and the array of cutting teeth 63 being the left most portion.

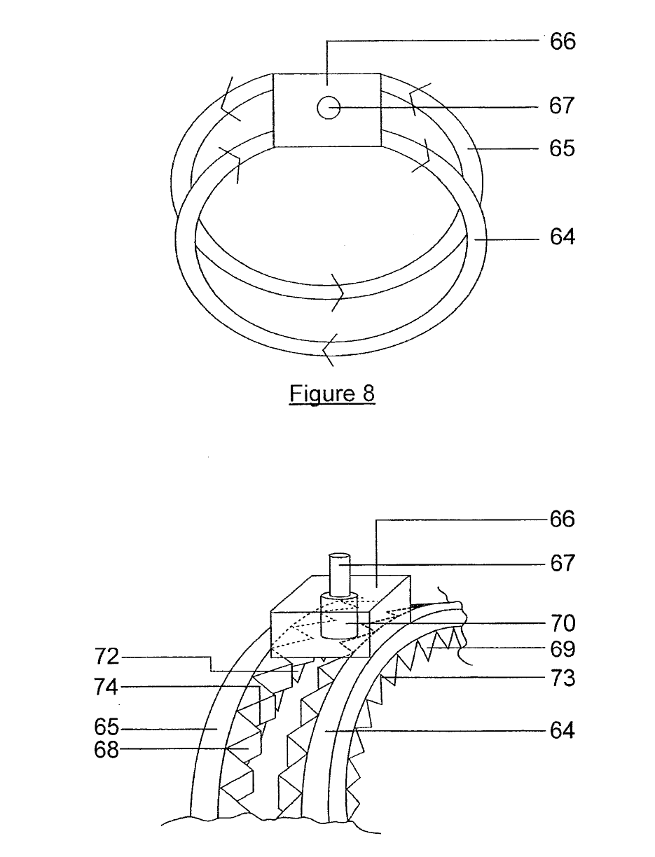

FIG. 8 shows an alternative embodiment of the pipe cutting and chamfering tool which comprises two annular shaped rings 64 and 65, which are connected about a pipe and driven by a common drive unit 66. The drive unit is driven via the drive shaft 67 which drives one annular ring 64 in one direction and the other annular ring 65 in the opposite direction simultaneously.

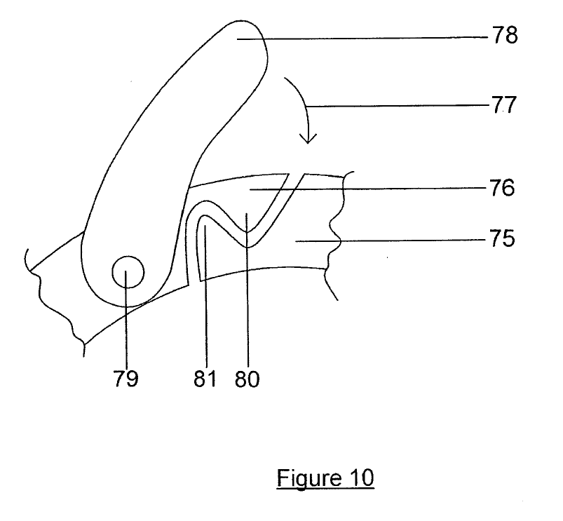

FIG. 9 shows the drive unit 66, which incorporates a drive shaft 67 and a drive wheel 70. Drive wheel 70 is engaged with an array of vertical teeth, which are located about the inner surface of annular ring 65. Drive wheel 70 is also simultaneously engaged with an array of vertical teeth, which are located about the inner surface of an annular ring 64. Annular ring 64 incorporates an array of teeth 69, which are located about the annular ring's 64 bottom surface that is in contact with the outer surface, of the pipe's diameter. Annular ring 65 incorporates an array of teeth 70, which is located about the annular ring's bottom surface 74, which is in contact with the outer surface of the pipe's diameter.

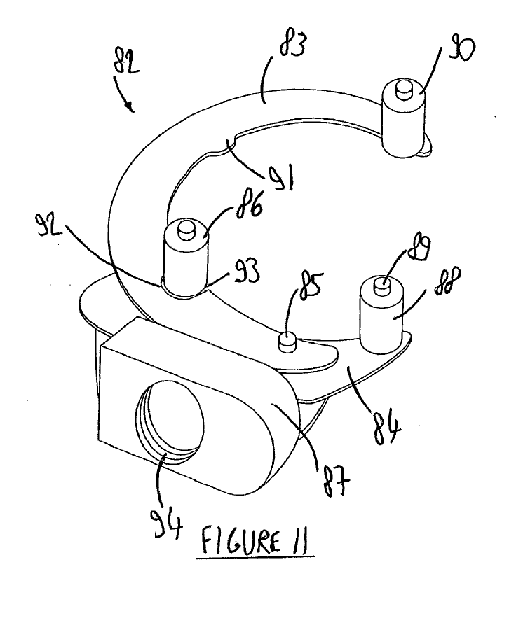

FIG. 10 shows the closing mechanism for the pipe cutting and chamfering tool. The closure mechanism is in two halves 75 and 76, which interlock through two hook shaped members 80 and 81. A lever clamp member 78 is provided to close over the junction of the halves. The clamp incorporates a pivot point 79 at one extremity and displaces towards half 75 as indicated by arrow 77. Clamp 78 is U-shaped in cross-section in order to straddle over the junction.

FIG. 11 shows a jaw generally referenced 82 with a first half 83 and a second half 84. Half 83 is substantially C-shaped and is pivotally secured to half 84 through pivot 85. The movement of half 83 is limited between roller 86 and housing 87. The jaw shown in FIG. 11 is in its closed position i.e. when half 83 abuts against roller 86. Roller 86 is attached to half 84. Similarly at the opposite extremity of half 84, roller 88 is attached to half 84. The rollers are freely rotatable about a central shaft such as shaft 89. The rollers may be of the kind employed in copper pipe chamfering tools which would marginally dig into the outer surface of the pipe which is to be chamfered. At the opposite extremity of half 83 a further roller 90 is provided. The three rollers 86, 88 and 90 form a clamping effect on the pipe circumference and act as a guide when the pipe is rotated relative to jaw 82. The rollers project at a right angle from the surface of halves 83 and 84 respectively. As part of the internal diameter of half 83 there is provided a radially projecting ear 91. Half 83 also incorporates an edge cut-out 92 which corresponds to the base portion 93 of roller 86.

Housing 87 is secured to half 84 and incorporates at its proximal extremity an opening 94 for receiving the head of a rotary power tool. The housing 87 may take the form of a split housing allowing the housing to be clamped to the head of the rotary tool. Any appropriate clamping means may be employed to secure the rotary power tool to the housing. The invention also envisages that the jaw 82 may be an integral part of a rotary power tool.

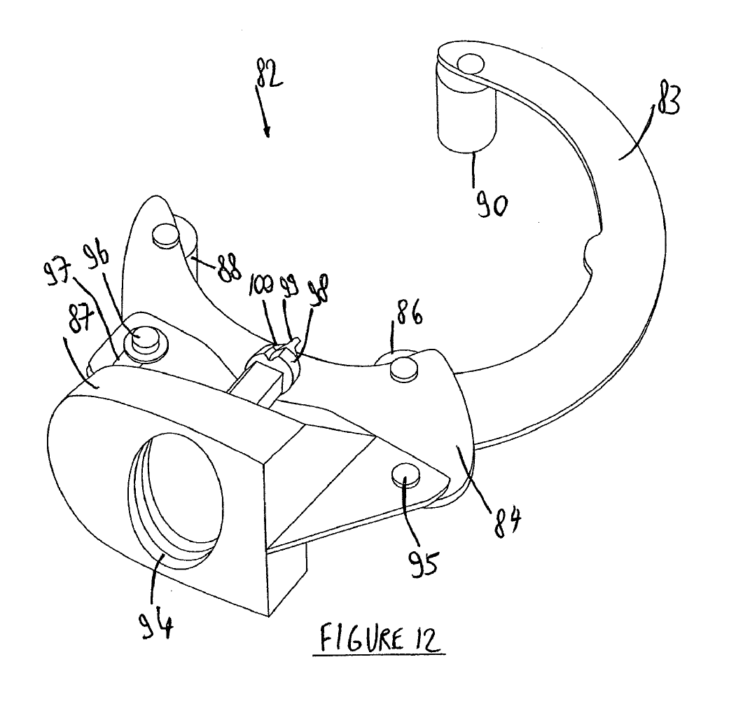

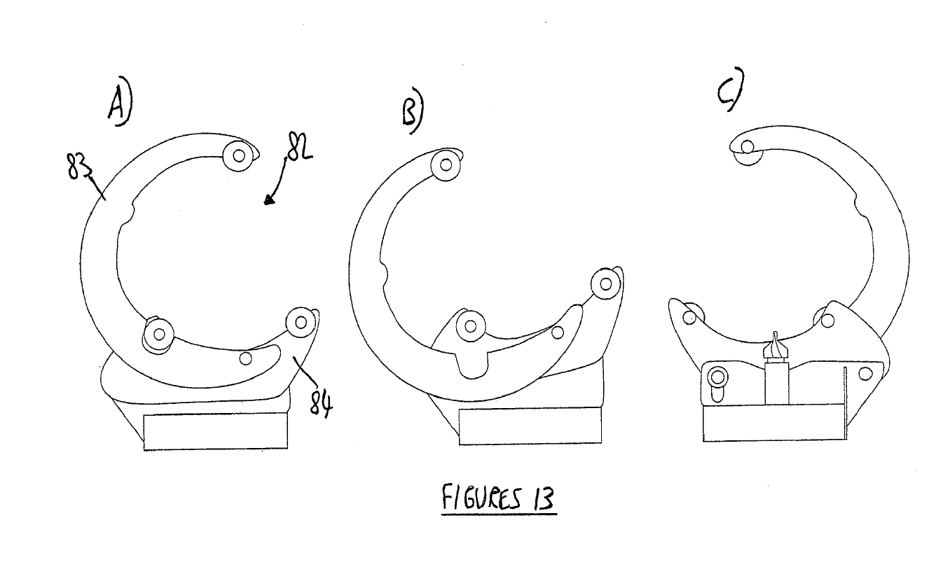

FIG. 12 shows jaw 82 from the opposite side in which identical components have retained identical references. Housing 87 is secured to half 84 via a pivot point 95. A second attachment means is provided in the form of a further fastener 96 which runs in a slot 97 which allows the housing to be slightly adjusted in order to allow the cutting and chamfering bit 98 to be displaced to and from a pipe as part of the cutting and chamfering operation. The chamfering and cutting bit incorporates a substantially cylindrical tip 99 which is primarily used to cut the pipe and a substantially conical portion 100 which is employed to cut in a chamfering form. Rollers 86, 88 and 90 may incorporate a pair of disc-shaped rollers at their upper and lower extremity which would engage and run against the circumference of a pipe. A spacer would be provided between the discs. This configuration allows the tool to be accurately guided at a right angle relative to the pipe.

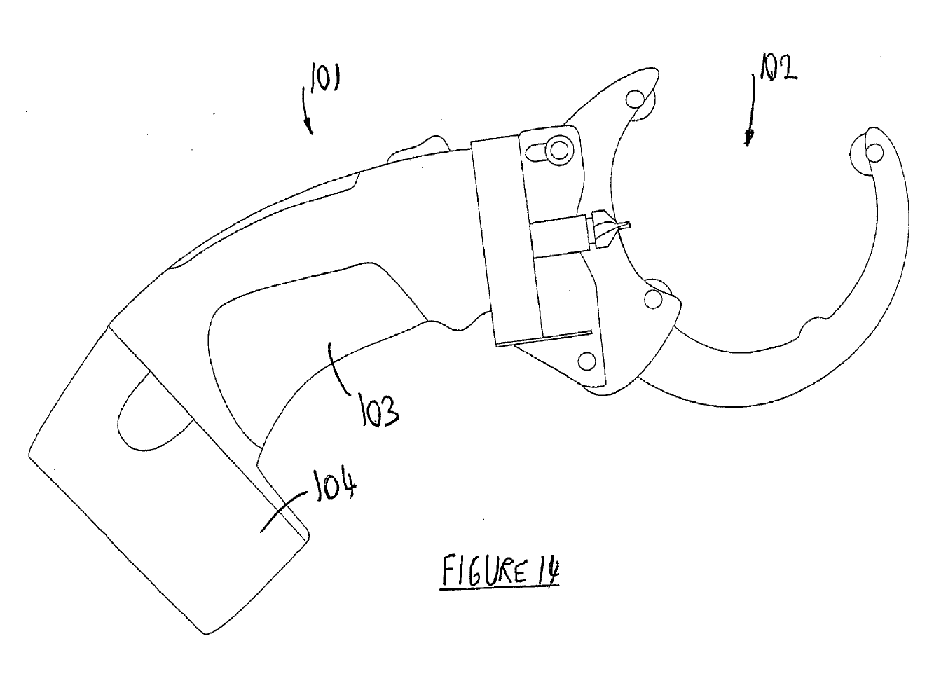

FIG. 13A shows the jaw 82 with halves 83 and 84 in their closed position. FIG. 13B shows halves 83 and 84 in their open position which allows the insertion of a pipe. FIG. 13C shows the jaw in its closed position with a drill bit ready for cutting and chamfering.

FIG. 14 shows the cutting and chamfering tool 101 which incorporates a jaw 102 of the kind described in the preceding FIGS. 11 to 13. The tool incorporates a handle 103 which is angled to assist with the cutting and chamfering operation. The tool incorporates a battery 104 at the rear portion of the tool. The battery may be rechargeable as per conventional power tools.

The jaw of the preceding figures may be formed in a plurality of sizes or may be extendable to and from a plurality of sizes such as in particular: 82 mm, 110 mm, and 160 mm.

1. A pipe cutting and chamfering tool comprising:
at least one cutting portions for severing the pipe into two portions;
at least one chamfering portions for chamfering the edges of said pipe portions; wherein the cutting and chamfering portions are configured to be driven; said wherein said tool incorporates a jaw for securing the tool onto a pipe from its side and for guiding the relative displacement of said pipe and said cutting and chamfering portions
wherein said jaw incorporates a first portion which is substantially C-shaped and a second portion;
wherein said first portion is pivotally mounted to said second portion;
wherein said first portion incorporating a laterally extending roller at its distal extremity;
wherein said second portion incorporating at least two laterally extending rollers provided respectively at distal and proximal positions of said second portion; and
wherein said first portion being pivotable relative to said second portion between a first position and a second position; whereby in said first position the jaw is sufficiently open to allow the tool to be located about a pipe from its side and in a second position where the jaw portions are brought closer together whilst their distal extremities remain apart so that in said second position said rollers engage said pipe to secure the tool to said pipe.

2-17. (canceled)

18. A tool according to claim 1, further comprising a housing for receiving a rotary power tool; said housing being pivotally mounted onto said second portion; whereby the cutting and chamfering portions may be displaced to and from said pipe.

19. A tool according to claim 1, wherein said rollers each incorporate a pair of discs configured to engage and run against the circumference of a pipe.

20. A tool according to claim 1, wherein at least one cutting portion is integrally formed with at least one chamfering portion.

21. A tool according to claim 20, wherein the cutting and chamfering portions incorporate at least one blade with a first edge portion angled for cutting and a second edge portion angled for chamfering.

22. A tool according to claim 1, further comprising a spigot protruding from said tool for engagement with a rotary power tool.

23. A tool according to claim 1, wherein said pipe cutting and chamfering tool is shaped and configured to be held and carried by hand; the tool incorporating a handle for carrying the tool whilst using the tool.

24. A jaw for use with a pipe cutting and chamfering tool according to claim 1, incorporating means for receiving and securing a power tool; wherein said jaw is sized and shaped to be secured about a pipe; said jaw incorporating a first portion which is substantially C-shaped and a second portion; wherein said first portion is pivotally mounted to said second portion; said first portion incorporating a laterally extending roller at its distal extremity; said second portion incorporating at least two laterally extending rollers provided respectively at distal and proximal positions of said second portion; said first portion being pivotable relative to said second portion between a first position and a second position; whereby in said first position the jaw is sufficiently open to allow the tool to be located about a pipe from its side and in a second position where the jaw portions are brought closer together whilst their distal extremities remain apart so that in said second position said rollers engage said pipe to secure the tool to said pipe.

25. A jaw according to claim 24, wherein said rollers each incorporate a pair of discs configured to engage and run against the circumference of a pipe.
